(19) United States
(12) Patent Application Publication
(10) Pub. No.: US 2023/0259886 A1
(43) Pub. Date: Aug. 17, 2023

(54) INFORMATION PROCESSING APPARATUS, INFORMATION PROCESSING METHOD, AND RECORDING MEDIUM

(71) Applicant: NEC Corporation, Minato-ku, Tokyo (JP)

(72) Inventors: Koki KITAYA, Tokyo (JP); Yoshinori SAIDA, Tokyo (JP); Hiroto ONISHI, Tokyo (JP); Daisuke TOKUSHIMA, Tokyo (JP); Kei SHIBUYA, Tokyo (JP); Kan ARAI, Tokyo (JP)

(73) Assignee: NEC Corporation, Minato-ku, Tokyo (JP)

(21) Appl. No.: 18/018,014

(22) PCT Filed: Jul. 30, 2020
(86) PCT No.: PCT/JP2020/029270

§ 371 Date: Jan. 25, 2023

(51) Int. Cl. G06Q 10/1053

(52) U.S. Cl. CPC G06Q 10/1053

(57) ABSTRACT

An information processing apparatus 1 includes: an acquisition unit 121 configured to acquire to-be-performed job data 1121 related to a to-be-performed job of a job performer and condition data 1122 indicating a condition for the job performer; an extraction unit 122 configured to extract, from among pieces of career data 1110 including past job data 1111 indicating details of a past job performed by an employee in the past and state data 1112 indicating a state of the employee at a time of performing the past job, at least one piece of the career data based on a degree of similarity S to the to-be-performed job data; a generation unit 123 configured to generate, based on the state data included in the extracted career data, a typical condition supposed to be a typical example of the condition for the job performer; and an output unit 124 configured to output, based on the condition indicated by the condition data and the typical condition, adequacy information related to adequacy of a relation between details of the to-be-performed job indicated by the to-be-performed job data and the condition for the job performer indicated by the condition data.

### TECHNICAL FIELD

The present disclosure relates to a technical field of an information processing apparatus, an information processing method, and a recording medium that can output information related to adequacy of a job description.

### BACKGROUND ART

In many cases, a company creates a job description that specifies details of a job to be performed by an employee, and a condition for the employee who performs the job (for example, at least one of a skill required of the employee and a remuneration to be received by the employee), and assigns (that is, appoints) an employee to a post in charge of the job, based on the job description.

Note that Patent Literatures 1 to 6 can be cited as background art references relevant to the present disclosure.

### CITATION LIST

### Patent Literature

### Patent Literature 1

International Publication No. WO 2002073488 Pamphlet

### Patent Literature 2

Japanese Translation of PCT International Application Publication No. 2004-503877

### Patent Literature 3

Japanese Patent Laid-Open No. 2001-290922

### Patent Literature 4

Japanese Patent Laid-Open No. 2019-061606

### Patent Literature 5

Japanese Translation of PCT International Application Publication No. 2018-501597

### Patent Literature 6

Japanese Patent Laid-Open No. 2005-115656

### SUMMARY

### Technical Problem

However, a job description created by a company is not always adequate. For example, a level of a condition for an employee specified in a job description may be too high or too low, compared to a level of a condition for an employee generally deemed necessary to perform a job specified in the job description. For example, a level of a job specified in a job description may be too high or too low, compared to a level of a job generally deemed able to be performed by an employee who meets a condition specified in the job description.

Considering the fact as described above that a job description created by a company is not always adequate, it is desirable that a measure to enhance adequacy of a job definition document is introduced, by providing information related to adequacy of the job description to the creator of the job description (for example, the above-described company).

An example object of the present disclosure is to provide an information processing apparatus, an information processing method, and a recording medium that can solve the above-described technical problem. As an example, an example object of the present disclosure is to provide an information processing apparatus, an information processing method, and a recording medium that can provide information related to adequacy of a job description.

### Solution to Problem

A first example aspect of an information processing apparatus in the present disclosure includes: an acquisition unit configured to acquire to-be-performed job data and condition data, the to-be-performed job data related to a to-be-performed job of a job performer in a predetermined post, the condition data indicating a condition for the job performer; an extraction unit configured to extract at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job; a generation unit configured to generate a typical condition based on the state data included in the career data extracted by the extraction unit, the typical condition supposed to be a typical example of the condition for the job performer who performs the to-be-performed job; and an output unit configured to output adequacy information based on the condition indicated by the condition data and the typical condition, the adequacy information related to adequacy of a relation between details of the to-be-performed job indicated by the to-be-performed job data and the condition for the job performer indicated by the condition data.

A second example aspect of an information processing apparatus in the present disclosure includes: an acquisition unit configured to acquire to-be-performed job data and condition data, the to-be-performed job data related to a to-be-performed job of a job performer in a predetermined post, the condition data indicating a condition for the job performer; a generation unit configured to generate a typical condition supposed to be a typical example of the condition for a candidate for the job performer who performs the to-be-performed job, based on state data included in career data that is similar to the to-be-performed job data, among pieces of the career data, the career data including past job data and the state data, the past job data indicating details of a past job performed by an employee in the past, the state data indicating a state of the employee at a time of performing the past job; and an output unit configured to output adequacy information based on the condition indicated by the condition data and the typical condition, the adequacy information related to adequacy of a relation between details of the to-be-performed job indicated by the to-be-performed job data and the condition for the candidate for the job performer indicated by the condition data.

One example aspect of an information processing method in the present disclosure includes: acquiring to-be-performed job data and condition data, the to-be-performed job data related to a to-be-performed job of a job performer in a predetermined post, the condition data indicating a condition for the job performer; extracting at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job; generating a typical condition based on the state data included in the extracted career data, the typical condition supposed to be a typical example of the condition for the job performer who performs the to-be-performed job; and outputting adequacy information based on the condition indicated by the condition data and the typical condition, the adequacy information related to adequacy of a relation between details of the to-be-performed job indicated by the to-be-performed job data and the condition for the job performer indicated by the condition data.

One example aspect of a recording medium in the present disclosure is a recording medium storing a computer program that causes a computer to execute an information processing method, the information processing method includes: acquiring to-be-performed job data and condition data, the to-be-performed job data related to a to-be-performed job of a job performer in a predetermined post, the condition data indicating a condition for the job performer; extracting at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job; generating a typical condition based on the state data included in the extracted career data, the typical condition supposed to be a typical example of the condition for the job performer who performs the to-be-performed job; and outputting adequacy information based on the condition indicated by the condition data and the typical condition, the adequacy information related to adequacy of a relation between details of the to-be-performed job indicated by the to-be-performed job data and the condition for the job performer indicated by the condition data.

### Effect

According to the present disclosure, it can be easily learned whether or not a job description is adequate.

### BRIEF DESCRIPTION OF DRAWINGS

FIG. 1 is a block diagram illustrating a configuration of an information processing apparatus in an example embodiment.

FIG. 2 is a data structure diagram illustrating an example of a data structure of career data.

FIG. 3 is a flowchart illustrating a flow of evaluation operation performed by the information processing apparatus.

FIG. 4 is a data structure diagram illustrating an example of a data structure of job description data.

FIGS. 5a to 5b are graphs each illustrating a relation between a typical condition and a job performer selection condition, for each type of an item representing a condition distinguishably from the other types.

FIG. 6 is a plan view illustrating a GUI for displaying an improvement policy on a job description.

FIG. 7 is a plan view illustrating a GUI for displaying a list of states (remunerations in an example shown in FIG. 7) of employees who performed past jobs that are relatively similar to a job to be performed.

### DESCRIPTION OF EXAMPLE EMBODIMENTS

Hereinafter, example embodiments of an information processing apparatus, an information processing method, and a recording medium are described with reference to the drawings. In the following, a description is given of an information processing apparatus 1 to which the example embodiments of the information processing apparatus, the information processing method, and the recording medium are applied.

The information processing apparatus 1 performs evaluation operation for evaluating adequacy of a job description. A job description is a document that specifies, for example, details of a job that a job performer assigned to a predetermined post (or a specific task) is requested to perform, and a condition for assignment to the predetermined post (or task) (for example, a condition related to a capability to perform the job). It is not limited what a job description is called, as long as the job description includes the above-described details. For example, a job description may be called “job definition document”. Such job descriptions may be created by, for example, companies and various business entities. Specifically, a job description is created by, for example, an internal organization (for example, human resources department, research and development department, intellectual property department, accounting department, procurement department, or the like) included in a company. The information processing apparatus 1 may be held by a company (or an internal organization in a company) that is the creator of a job description. The information processing apparatus 1 may be used by a company that is the creator of a job description. Alternatively, the information processing apparatus 1 may be used, as a so-called cloud service, by a company that is the creator of a job description. In such a case, the company does not necessarily need to hold the information processing apparatus 1. However, the information processing apparatus 1 may be held and/or used by a different entity from the creator of a job description, as will be described later.

### (1) Configuration of Information Processing Apparatus 1

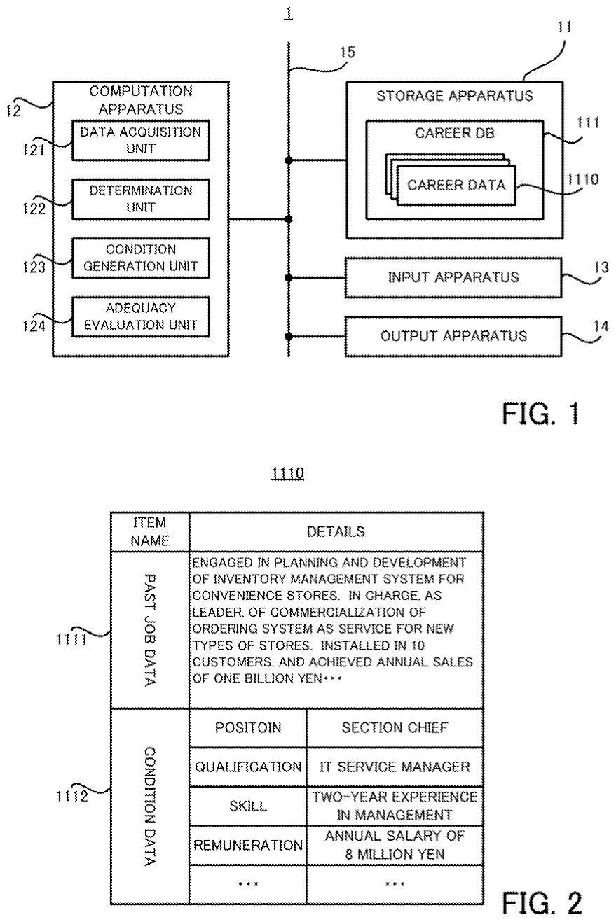

First, a configuration of the information processing apparatus 1 in the present example embodiment is described with reference to FIG. 1. FIG. 1 is a block diagram illustrating the configuration of the information processing apparatus 1.

As shown in FIG. 1, the information processing apparatus 1 includes a storage apparatus 11 and a computation apparatus 12. Further, the information processing apparatus 1 may include an input apparatus 13 and an output apparatus 14. However, the information processing apparatus 1 may omit to include at least one of the input apparatus 13 and the output apparatus 14. The storage apparatus 11, the computation apparatus 12, the input apparatus 13, and the output apparatus 14 may be connected through a data bus 15.

The storage apparatus 11 can store desired data. For example, the storage apparatus 11 may temporarily store a computer program to be executed by the computation apparatus 12. The storage apparatus 11 may temporarily store data that the computation apparatus 12 temporarily uses when the computation apparatus 12 executes the computer program. The storage apparatus 11 may store data that is retained by the information processing apparatus 1 for a long time. Note that the storage apparatus 11 may include at least one of a RAM (Random Access Memory), a ROM (Read Only Memory), a hard disk device, a magneto-optical disk device, an SSD (Solid State Drive), and a disk array device. In other words, the storage apparatus 11 may include a non-transitory recording medium.

In the present example embodiment, data that the information processing apparatus 1 uses to perform the evaluation operation is recorded in the storage apparatus 11. In FIG. 1, a career DB (database) 111 is presented as an example of the data that the information processing apparatus 1 uses to perform the evaluation operation. In other words, FIG. 1 shows an example in which the storage apparatus 11 stores the career DB 111.

The career DB 111 stores a plurality of pieces of career data 1110. The plurality of pieces of career data 1110 include data related to careers of a plurality of different employees, respectively. In other words, each piece of career data 1110 includes data related to a career of an employee corresponding to the piece of career data 1110. To put it another way, the career DB 111 stores career data 1110 related to a career of an employee.

The career DB 111 may include career data 1110 related to a career of an employee who is currently employed by a company (hereinafter, referred to as “user company”) that uses the information processing apparatus 1. The career DB 111 may include career data 1110 related to a career of an employee who was employed in the past by the user company. However, the career DB 111 may include career data 1110 related to a career of a different person from the employee who is currently employed or was employed in the past by the user company. For example, the career DB 111 may include career data 1110 related to a career of an employee who is currently employed or was employed in the past by another company different from the user company. For example, the career DB 111 may include career data 1110 related to a career of a solo proprietor who is not employed by the user company (or another company). In the following description, it is assumed that employees include not only a worker who signs an employment contract with a company, but also a worker who does not sign an employment contract with a company (for example, a person who signs an outsourcing contract with the user company, such as a solo proprietor).

An example of a data structure of the career data 1110 is shown in FIG. 2. As shown in FIG. 2, the career data 1110 may include past job data 1111 and state data 1112.

The past job data 1111 is data related to a job (hereinafter, referred to as “past job”) that was performed in the past by an employee. For example, the past job data 1111 may be text data indicating details of the past job in text. In the example shown in FIG. 2, the past job data 1111 indicates that “the past job is a job in charge of planning and development of an inventory management system for convenience stores, and is a job in charge, as a leader, of commercialization of an ordering system as a service for new types of stores.”

The details of the past job may include a result achieved by the employee in the past job (that is, an actual achievement or a business performance of the employee). In other words, the past job data 1111 may include data indicating a result achieved by the employee in the past job, as at least part of the data indicating the details of the past job. For example, in the example shown in FIG. 2, the past job data 1111 indicates that “the result achieved by the employee in the past job is that the ordering system as a service was installed in 10 customers, and consequently annual sales of one billion yen were brought about.”

The state data 1112 is data indicating a state of the employee when the employee performed the past job. A state of an employee here refers to a personnel state (status) of the employee. As shown in FIG. 2, as an example of the state of the employee, the state data 1112 may indicate a position (for example, a status, a title, or a rank) of the employee at the time of performing the past job. As an example of the state of the employee, the state data 1112 may indicate a qualification held by the employee at the time of performing the past job. The qualification indicated by the state data 1112 may include at least one of, for example, a national qualification, a public qualification, a private qualification, and an international qualification. As an example of the state of the employee, the state data 1112 may indicate a skill possessed by the employee at the time of performing the past job. The skill indicated by the state data 1112 may include at least one of, for example, a management skill, a technical skill, an IT skill, a sales skill, and a communication skill. As an example of the state of the employee, the state data 1112 may indicate a remuneration (for example, an annual salary or the like) paid to the employee at the time of performing the past job. In addition, the state data 1112 may include an evaluation comment (not shown in FIG. 2) made by a superior or a colleague of the employee. Note that the state data 1112 may indicate any other state that can be relevant to output of adequacy information.

The state data 1112 may be data that indicates the state of the employee by using a numerical value. For example, the state data 1112 may be data that indicates the position of the employee by using a numerical value determined according to a variation of position (for example, a numerical value that becomes larger as the level of the status or the title becomes higher). For example, the state data 1112 may be data that indicates the qualification of the employee by using a numerical value determined according to a variation of qualification (for example, a numerical value that becomes larger as the level of a qualification becomes higher and/or the number of qualifications becomes larger). For example, the state data 1112 may be data that indicates the skill of the employee by using a numerical value determined according to a variation of skill (for example, a numerical value that becomes larger as the level of a skill becomes higher). For example, the state data 1112 may be data that indicate the remuneration of the employee by using a numerical value determined according to a variation of remuneration (for example, a numerical value that becomes larger as the remuneration becomes larger).

When the employee performed a plurality of different past jobs in the past, the career data 1110 may include a plurality of pieces of past job data 1111 indicating details of the plurality of different past jobs, respectively. Further, the career data 1110 may include a plurality of pieces of state data 1112 corresponding to the plurality of pieces of past job data 1111, respectively. Each piece of state data 1112 indicates a state of the employee at the time of performing a past job indicated by one piece of past job data 1111 corresponding to the piece of state data 1112. For example, the career data 1110 may include first past job data 1111 indicating details of a first past job performed by the employee in a first period, second past job data 1111 indicating details of a second past job performed by the employee in a second period, first state data 1112 indicating a state of the employee in the first period when the first past job was performed, and second state data 1112 indicating a state of the employee in the second period when the second past job was performed.

Referring again to FIG. 1, the computation apparatus 12 includes, for example, a CPU (Central Processing Unit). The computation apparatus 12 reads a computer program. For example, the computation apparatus 12 may read the computer program stored in the storage apparatus 11. For example, the computation apparatus 12 may read the computer program stored in a computer-readable non-transitory recording medium, by using an undepicted recording medium reading device. The computation apparatus 12 may acquire (that is, may download or may read), via an undepicted communication device, the computer program from an undepicted device placed outside the information processing apparatus 1. The computation apparatus 12 executes the read computer program. As a result, a logical functional block for performing an operation (for example, the above-described evaluation operation) to be performed by the information processing apparatus 1 is implemented within the computation apparatus 12. In other words, the computation apparatus 12 can function as a controller for implementing a logical functional block for performing an operation to be performed by the information processing apparatus 1.

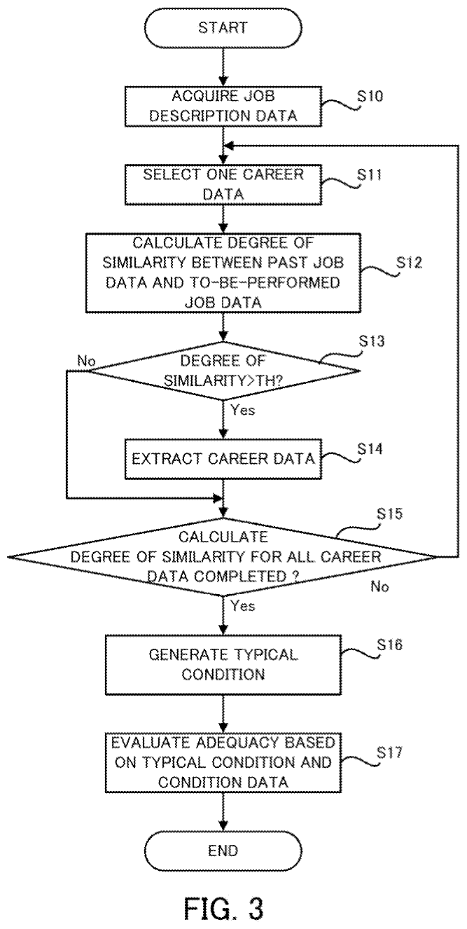

FIG. 1 shows an example of logical functional block implemented within the computation apparatus 12 in order to perform the evaluation operation. As shown in FIG. 1, a data acquisition unit 121 that is a specific example of an “acquisition unit”, a determination unit 122 that is a specific example of an “extraction unit”, a condition generation unit 123 that is a specific example of a “generation unit”, and an adequacy evaluation unit 124 that is a specific example of each of an “output unit” and an “evaluation unit” are implemented within the computation apparatus 12. Note that details of operation by the data acquisition unit 121, the determination unit 122, the condition generation unit 123, and the adequacy evaluation unit 124 will be described specifically later with reference to FIG. 3 and the like.

The input apparatus 13 is an apparatus that receives input of information to the information processing apparatus 1 from an outside of the information processing apparatus 1. For example, the input apparatus 13 may include an operation apparatus (for example, at least one of a key board, a mouse, and a touch panel) that can be operated by a user of the information processing apparatus 1. For example, the input apparatus 13 may include a reception apparatus that can receive information transmitted as data to the information processing apparatus 1 from the outside of the information processing apparatus 1 via a communication network.

The output apparatus 14 is an apparatus that outputs information. For example, the output apparatus 14 may output information related to the evaluation operation performed by the information processing apparatus 1. For example, the output apparatus 14 may output information related to adequacy of a job description evaluated through the evaluation operation performed by the information processing apparatus 1. An example of such an output apparatus 14 is a display (display apparatus) that can output (that is, can display) the information as an image. An example of the output apparatus 14 is a speaker (audio output apparatus) that can output the information as audio. An example of the output apparatus 14 is a printer that can output a document on which the information is printed. An example of the output apparatus 14 is a transmission apparatus that can transmit the information as data via the communication network or the data bus.

### (2) Processing Operation Performed by Information Processing Apparatus 1

Next, processing operation (that is, the above-mentioned evaluation operation) performed by the information processing apparatus 1 is described with reference to FIG. 3. FIG. 3 is a flowchart illustrating a flow of the processing operation performed by the information processing apparatus 1.

As shown in FIG. 3, the data acquisition unit 121 acquires job description data 1120 (step S10). For example, the data acquisition unit 121 may acquire the job description data 1120 from the outside of the information processing apparatus 1 via the input apparatus 13. For example, when the job description data 1120 is stored in the storage apparatus 11, the data acquisition unit 121 may acquire (that is, may read) the job description data 1120 from the storage apparatus 11.

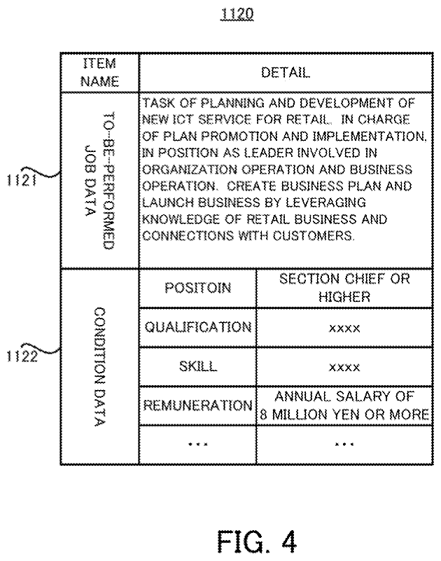

The job description data 1120 is data that presents a job description in a form that can be processed by the information processing apparatus 1. As described above, the job description is a document including, for example, information related to details of a job (hereinafter, referred to as “to-be-performed job”) that should be performed by a job performer assigned to a predetermined post, and information related to a condition for the job performer who performs the to-be-performed job. Accordingly, as shown in FIG. 4, which shows an example of the job description data 1120, the job description data 1120 may include to-be-performed job data 1121 and condition data 1122.

The to-be-performed job data 1121 is data related to the to-be-performed job of the job performer in the predetermined post. Typically, the to-be-performed job data 1121 may be data indicating details of the to-be-performed job that should be performed by the job performer. For example, the to-be-performed job data 1121 may be text data indicating the details of the to-be-performed job in text. In the example shown in FIG. 4, the to-be-performed job data 1121 indicates that “the to-be-performed job is a job in charge of planning and development of a new ICT (Information Communication Technology) service for retail, is a job in charge of plan promotion and plan implementation for the new ICT service, as a leader involved with organization operation and business operation, and is a job of creating a business plan and launching the business by leveraging knowledge of retail business and connections with customers.”

The details of the to-be-performed job may include a result (that is, an actual achievement or a business performance) that the job performer is expected to achieve in the to-be-performed job. In other words, the to-be-performed job data 1121 may include data indicating a result that the job performer is expected to achieve in the to-be-performed job, as at least part of the data indicating the details of the to-be-performed job.

The condition data 1122 is data indicating a condition required of the job performer who performs the to-be-performed job. As shown in FIG. 3, as an example of the condition for the job performer, the condition data 1122 may indicate a position (for example, a status, a title, or a rank) required of the job performer. As an example of the condition for the job performer, the condition data 1122 may indicate a qualification required of the job performer. The qualification indicated by the condition data 1122 may include at least one of, for example, a national qualification, a public qualification, a private qualification, and an international qualification. As an example of the condition for the job performer, the condition data 1122 may indicate a skill required of the job performer. The skill indicated by the condition data 1122 may include at least one of, for example, a management skill, a technical skill, an IT skill, a sales skill, and a communication skill. As an example of the condition for the job performer, the condition data 1122 may indicate a remuneration (for example, an annual salary or the like) to be paid to the job performer. Note that the condition data 1122 may indicate any other condition that can be relevant to output of adequacy information.

As shown in FIGS. 2 and 4, types of items representing the conditions for the job performer indicated by the condition data 1122 may be the same as types of items representing the states of an employee indicated by the above-described state data 1112. In the examples shown in FIGS. 2 and 4, the state data 1112 indicates four types of items including position, qualification, skill, and remuneration as the states of an employee, and the condition data 1122 indicates the same four types of items including position, qualification, skill, and remuneration as the conditions for the job performer. However, the types of items representing the conditions for the job performer indicated by the condition data 1122 may be at least partially different from the types of items representing the states of an employee indicated by the above-described state data 1112. In other words, the condition data 1122 may indicate conditions for the job performer represented by different types of items from the items representing the states of the employee indicated by the state data 1112. The state data 1112 may indicate states of an employee represented by different types of items from the items representing the conditions for the job performer indicated by the condition data 1122.

The condition data 1122 may be data that indicates the condition for the job performer by using a numerical value. For example, the condition data 1122 may be data that indicates the position of the job performer by using a numerical value determined according to a variation of position (for example, a numerical value that becomes larger as the level of the status or the title becomes higher). For example, the condition data 1122 may be data that indicates the qualification of the job performer by using a numerical value determined according to a variation of qualification (for example, a numerical value that becomes larger as the level of a qualification becomes higher and/or the number of qualifications becomes larger). For example, the condition data 1122 may be data that indicates the skill of the job performer by using a numerical value determined according to a variation of skill (for example, a numerical value that becomes larger as the level of a skill becomes higher). For example, the condition data 1122 may be data that indicates the remuneration of the job performer by using a numerical value determined according to a variation of remuneration (for example, a numerical value that becomes larger as the remuneration becomes larger).

Referring again to FIG. 3, thereafter, the determination unit 122 selects one piece of career data 1110 from among a plurality of pieces of career data 1110 stored in the career DB 111 (step S11). Thereafter, the determination unit 122 calculates a degree of similarity S between past job data 1111 included in the one piece of career data 1110 selected in step S11, and the to-be-performed job data 1121 included in the job description data 1120 acquired in step S10 (step S12).

As described above, the past job data 1111 may be text data indicating details of a past job in text, and the to-be-performed job data 1121 may be text data indicating the details of the to-be-performed job in text. In such a case, the determination unit 122 may calculate the degree of similarity S by using natural language processing.

As an example, for example, the determination unit 122 may subdivide the text indicating the details of the past job in units of words (or morphemes), by performing, on the past job data 1111, natural language processing including at least one of morphological analysis and syntax analysis. Similarly, for example, the determination unit 122 may subdivide the text indicating the details of the to-be-performed job in units of words (or morphemes), by performing, on the to-be-performed job data 1121, natural language processing including at least one of morphological analysis and syntax analysis. Thereafter, the determination unit 122 may calculate, by using a word vector space including a list of a large number of words converted into vectors, a distance (that is, a distance in the word vector space) between a string of the words included in the text indicating the details of the past job and a string of the words included in the text indicating the details of the to-be-performed job. Thereafter, the determination unit 122 may calculate the degree of similarity S, based on the calculated distance. Specifically, the shorter the calculated distance is, the more similar the string of the words included in the text indicating the details of the past job and the string of the words included in the text indicating the details of the to-be-performed job are deemed. In other words, the details of the past job and the details of the to-be-performed job are deemed similar. To put it another way, the past job data 1111 and the to-be-performed job data 1121 are deemed similar. Accordingly, the determination unit 122 may calculate the degree of similarity S in such a manner that the shorter the calculated distance is, the larger the degree of similarity S is.

Note that the word vector space may be generated beforehand by the information processing apparatus 1, or another information processing apparatus different from the information processing apparatus 1, before the information processing apparatus 1 starts the evaluation operation. For example, the information processing apparatus 1 (or the other information processing apparatus; hereinafter, the same applies in the current paragraph) may generate the word vector space (in other words, a vector space model), by performing, on data related to a career of an arbitrary person, natural language processing for converting words into vectors. An example of the natural language processing for converting words into vectors is, for example, natural language processing based on Word2vec. Moreover, the data on which the natural language processing for generating the word vector space is performed may include at least one or some of the plurality of pieces of career data 1110 stored in the career DB 111. The data on which the natural language processing for generating the word vector space is performed may include career data 1110 that is not stored in the career DB 111 (for example, that is stored in an external apparatus outside of the information processing apparatus 1). The career data 1110 that is not stored in the career DB 111 may include data related to a career of an employee who is currently employed or was employed in the past by another company different from the user company. The career data 1110 that is not stored in the career DB 111 may include data related to a career of a solo proprietor who is not employed by the user company (or another company).

As another example, the determination unit 122 may calculate a degree of matching between the words included in the text indicating the details of the past job and the words included in the text indicating the details of the to-be-performed job. For example, the determination unit 122 may calculate, as the degree of matching, the number of words, among the plurality of words included in the text indicating the details of the past job, that match words included in the text indicating the details of the to-be-performed job. Thereafter, the determination unit 122 may calculate the degree of similarity S, based on the calculated degree of matching. Specifically, the larger the calculated degree of matching is, the more similar the words included in the text indicating the details of the past job and the words included in the text indicating the details of the to-be-performed job are deemed. In other words, the details of the past job and the details of the to-be-performed job are deemed similar. To put it another way, the past job data 1111 and the to-be-performed job data 1121 are deemed similar. Accordingly, the determination unit 122 may calculate the degree of similarity S in such a manner that the larger the calculated degree of matching is, the larger the degree of similarity S is. Alternatively, the calculated degree of matching may be used as it is for the degree of similarity S.

Thereafter, based on the degree of similarity S calculated in step S12, the determination unit 122 extracts career data 1110 that includes the past job data 1111 similar to the to-be-performed job data 1121. As an example of such operation, the determination unit 122 determines whether or not the degree of similarity S calculated in step S12 is larger than a predetermined threshold value TH (step S13).

When it is determined, as a result of the determination in step S13, that the degree of similarity S is larger than the predetermined threshold value TH (step S13: Yes), the determination unit 122 extracts the career data 1110 selected in step S11, as data to be used to evaluate adequacy of the job description data 1120 (that is, adequacy of the job description indicated by the job description data 1120) (step S14). Note that in the following description, the career data 1110 extracted in step S14 is referred to as “extracted data 1113”, and is thereby distinguished from career data 1110 that is not extracted in step S14.

In contrast, when it is determined, as a result of the determination in step S13, that the degree of similarity S is smaller than the predetermined threshold value TH (step S13: No), the determination unit 122 does not need to extract the career data 1110 selected in step S11, as data to be used to evaluate adequacy of the job description data 1120. Note that when it is determined in step S13 that the degree of similarity S is equal to the predetermined threshold value TH, the determination unit 122 may extract, or may omit to extract, the career data 1110 selected in step S11, as data to be used to evaluate adequacy of the job description data 1120.

The determination unit 122 may calculate the degree of similarity S, with a specific item weighted, among the items included in the career data. For example, the determination unit 122 may calculate the degree of similarity S, with the held qualification weighted. Thus, since the determination unit 122 can extract, as the extracted data 1113, the career data 1110 including the past job data 1111 that is more similar, in the specific item, to the to-be-performed job data 1121, accuracy in adequacy determination can be enhanced. Note that an item to be weighted may be able to be set by the user as appropriate, or may be preset.

The predetermined threshold value TH is set to an appropriate value that makes it possible to distinguish between career data 1110 that should be extracted to evaluate adequacy of the job description data 1120 and career data 1110 that does not need to be extracted to evaluate adequacy of the job description data 1120, based on the degree of similarity S between the career data 1110 and the job description data 1120. For example, the predetermined threshold value TH is set to an appropriate value that makes it possible to distinguish, based on the degree of similarity S, between career data 1110 that should preferably be extracted to evaluate adequacy of the job description data 1120 because the career data 1110 includes the past job data 1111 that is relatively similar to the to-be-performed job data 1121 in the job description data 1120, and career data 1110 that does not need to be extracted to evaluate adequacy of the job description data 1120 because the career data 1110 includes the past job data 1111 that is not much similar to the to-be-performed job data 1121 in the job description data 1120.

The determination unit 122 repeats the above-described operation from step S11 to step S14, for each of the plurality of pieces of career data 1110 stored in the career DB 111 (step S15). In other words, the determination unit 122 repeats the operation of selecting one new piece of career data 1110 for which the degree of similarity S is not yet calculated, among the plurality of pieces of career data 1110 stored in the career DB 111 (step S11), and determining whether or not to extract the selected new piece of career data 1110 to evaluate adequacy of the job description data 1120 (steps S12 to S14), until the degree of similarity S is calculated for all of the plurality of pieces of career data 1110 stored in the career DB 111. However, the determination unit 122 may terminate the operation from step S11 to step S15 when the degree of similarity S is calculated for one or some of the plurality of pieces of the career data 1110 stored in the career DB 111.

Thereafter, by using at least one piece of the extracted data 1113 extracted in step S14, the condition generation unit 123 generates a typical condition that is supposed to be a typical example of the condition for the job performer who performs the to-be-performed job (step S16). In other words, by using at least one piece of the extracted data 1113 extracted in step S14, the condition generation unit 123 generates a typical condition that is supposed to be a typical example of the condition for a person as a candidate for the job performer who performs the to-be-performed job (step S16). Specifically, the extracted data 1113 includes the past job data 1111 that is relatively similar to the to-be-performed job data 1121. In other words, the extracted data 1113 includes the past job data 1111 indicating the past job that is relatively similar to the to-be-performed job indicated by the to-be-performed job data 1121. Accordingly, the state data 1112 included in the extracted data 1113 indicates a state of an employee who actually performed the past job that is relatively similar to the to-be-performed job. In such a case, it can be said that the state data 1112 included in the extracted data 1113 includes information related to the typical example of the condition for the job performer who performs the to-be-performed job that is relatively similar to the past job. Accordingly, the condition generation unit 123 generates the typical condition by using the state data 1112 included in at least one piece of the extracted data 1113 extracted in step S14.

As an example, the condition generation unit 123 may generate the typical condition by averaging the state data 1112 included in the extracted data 1113. Specifically, the condition generation unit 123 may calculate an average state of employees who performed the past jobs, by averaging the state data 1112 included in the extracted data 1113, and may generate the typical condition based on the calculated average state of the employees. In such a case, the typical condition is a condition based on the calculated average state of the employees. The calculated average state of the employees corresponds to the typical example of the condition for the job performer who performs the to-be-performed job that is relatively similar to the past jobs. Accordingly, the condition generation unit 123 may set the calculated average state of the employees, as the typical condition. In such a case, the condition generation unit 123 can appropriately generate the typical condition.

In such a case, the condition generation unit 123 may calculate the average state of the employees at a time when the employees performed the past jobs, by averaging the state data 1112 included in the extracted data 1113 for each type of an item representing a state of the employees. For example, the condition generation unit 123 may calculate an average position of the employees at the time when the employees performed the past jobs, and may set the calculated average position of the employees as a typical example of the position required of the job performer (that is, a position-related typical condition). For example, the condition generation unit 123 may calculate an average qualification of the employees at the time when the employees performed the past jobs, and may set the calculated average qualification of the employees as a typical example of the qualification required of the job performer (that is, a qualification-related typical condition). For example, the condition generation unit 123 may calculate the proportion of employees who held a specific qualification at the time when the employees performed the past jobs (for example, the proportion of the number of employees who performed the past jobs and held the specific qualification to the total number of the employees who performed the past jobs; referred to as holding ratio), and, when the holding ratio is equal to or more than a threshold value (for example, 50%), may generate the typical condition that holding of the specific qualification is a requisite condition. For example, the condition generation unit 123 may calculate an average skill of the employees at the time when the employees performed the past jobs, and may set the calculated average skill of the employees as a typical example of the skill required of the job performer (that is, a skill-related typical condition). For example, the condition generation unit 123 may calculate an average remuneration of the employees at the time when the employees performed the past jobs, and may set the calculated average remuneration of the employees as a typical example of the remuneration to be paid to the job performer (that is, a remuneration-related typical condition).

Note that the extracted data 1113 (that is, career data 1110) may be data indicating the state of an employee by using a numerical value, as described above. Accordingly, the condition generation unit 123 can average the state data 1112 included in the extracted data 1113. The condition generation unit 123 can calculate the average state of the employees who performed the past jobs, by averaging the state data 1112 included in the extracted data 1113. However, if the extracted data 1113 is not data indicating the state of an employee by using a numerical value, the condition generation unit 123 may generate the average state of the employees by performing, on the state data 1112, a predetermined arithmetic operation for calculating an average state of employees.

Alternatively, the condition generation unit 123 may identify one piece of the extracted data 1113 that includes the past job data 1111 with the largest degree of similarity S to the to-be-performed job data 1121, and may generate the typical condition based on the state of the employee indicated by the state data 1112 included in the identified piece of the extracted data 1113. For example, the condition generation unit 123 may set the state of the employee indicated by the state data 1112 included in the identified piece of the extracted data 1113, as the typical condition. In such a case, the typical condition is a condition based on the state of the employee indicated by the state data 1112 included in the identified piece of the extracted data 1113. The identified piece of the extracted data 1113 indicates the state of the employee at a time when the employee performed the past job that is most similar to the to-be-performed job. Accordingly, the state of the employee indicated by the state data 1112 included in the identified piece of the extracted data 1113 is a typical example of the condition for the job performer who performs the to-be-performed job that is relatively similar to the past job. In such a case, the condition generation unit 123 can also appropriately generate the typical condition.

Thereafter, based on the typical condition generated in step S16 and the condition data 1122 included in the job description data 1120 acquired in step S10, the adequacy evaluation unit 124 evaluates adequacy of the job description data 1120 (that is, adequacy of the job description indicated by the job description data 1120) (step S17).

For example, the adequacy evaluation unit 124 may evaluate whether adequacy of the job description data 1120 is present or absent, by comparing the typical condition and the condition for the job performer indicated by the condition data 1122. Adequacy of the job description data 1120 may include adequacy related to a relation between the details of the to-be-performed job indicated by the to-be-performed job data 1121 included in the job description data 1120 and the condition indicated by the condition data 1122 included in the job description data 1120. Note that the condition for the job performer indicated by the condition data 1122 is used mainly to select the job performer who performs the to-be-performed job. Accordingly, in the following description, the condition for the job performer indicated by the condition data 1122 is referred to as “job performer selection condition” as deemed appropriate, for explanatory convenience.

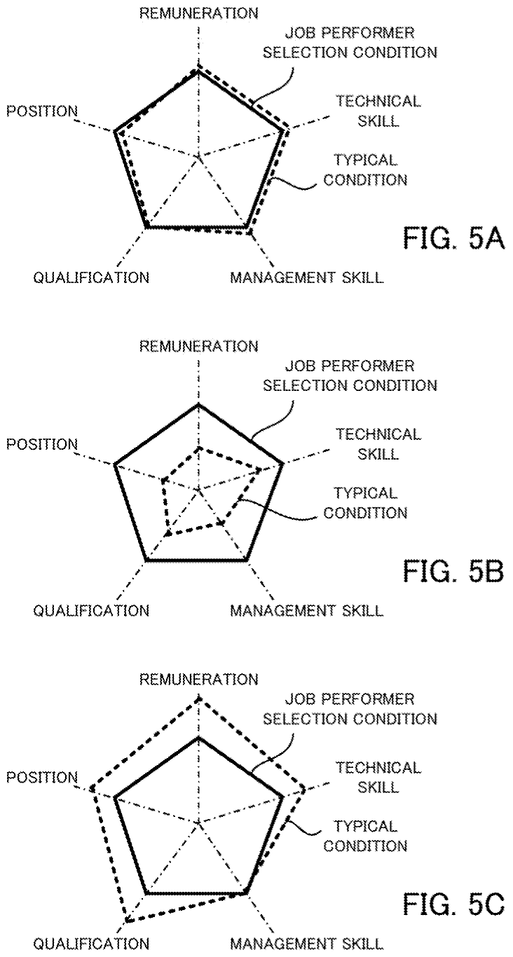

Specifically, FIG. 5a is a graph (radar chart in the present case) illustrating a relation between a typical condition and a job performer selection condition with no difference or a relatively small difference therebetween, for each type of an item representing a condition distinguishably from the other types. As shown in FIG. 5a, when there is no difference, or a relatively small difference, between the typical condition and the job performer selection condition, the condition data 1122 indicates the job performer selection condition that is approximately the same as the typical condition generally supposed to be a typical example of the condition for the job performer. In other words, the condition data 1122 indicates the job performer selection condition that is approximately the same as a condition for an employee who actually performed a past job that is relatively similar to the to-be-performed job. Accordingly, it is highly probable that the job performer selection condition indicated by the condition data 1122 is adequate for the condition for the job performer who performs the to-be-performed job. To put it the other way around, it is highly probable that the to-be-performed job indicated by the to-be-performed job data 1121 is adequate for the job that should be performed by the job performer who meets the job performer selection condition. In other words, it is highly probable that a relation between the details of the to-be-performed job indicated by the to-be-performed job data 1121 and the condition indicated by the condition data 1122 is adequate.

On the other hand, each of FIGS. 5b and 5c is a graph (radar chart in the present case) illustrating a relation between a typical condition and a job performer selection condition with a relatively large difference therebetween, for each type of an item representing a condition distinguishably from the other types. As shown in FIGS. 5b and 5c, when there is a relatively large difference between the typical condition and the job performer selection condition, the condition data 1122 indicates the job performer selection condition that relatively greatly deviates from the typical condition generally supposed to be a typical example of the condition for the job performer. In other words, the condition data 1122 indicates the job performer selection condition that relatively greatly deviates from a condition for an employee who actually performed a past job that is relatively similar to the to-be-performed job. Accordingly, it is highly probable that the job performer selection condition indicated by the condition data 1122 is not adequate for the condition for the job performer who performs the to-be-performed job. Specifically, FIG. 5b shows an example in which the level of a job performer who meets the job performer selection condition is unnecessarily high, compared to the level of a job performer who meets the typical condition. In such a case, it is probable that the level of the job performer selection condition indicated by the condition data 1122 is higher than necessary as a level of the condition for the job performer who performs the to-be-performed job. To put it the other way around, it is probable that the degree of difficulty of the to-be-performed job indicated by the to-be-performed job data 1121 is unnecessarily too low, for the job performer who meets the job performer selection condition to perform. Similarly, FIG. 5c shows an example in which the level of a job performer who meets the job performer selection condition is unnecessarily low, compared to the level of a job performer who meets the typical condition. In such a case, it is probable that the level of the job performer selection condition indicated by the condition data 1122 is lower than necessary as a level of the condition for the job performer who performs the to-be-performed job. To put it the other way around, it is probable that the degree of difficulty of the to-be-performed job indicated by the to-be-performed job data 1121 is unnecessarily too high, for the job performer who meets the job performer selection condition to perform.

As described above, when there is a relatively large difference between the typical condition and the job performer selection condition, it is probable that at least one of the to-be-performed job and the job performer selection condition is not adequate. In other words, when there is a relatively large difference between the typical condition and the job performer selection condition, it is probable that the job description indicated by the job description data 1120 is not adequate. Specifically, it is probable that a relation between the details of the to-be-performed job indicated by the to-be-performed job data 1121 and the condition indicated by the condition data 1122 is not adequate. Accordingly, in the present example embodiment, when the difference between the typical condition and the job performer selection condition is smaller than a predetermined allowance threshold value, the adequacy evaluation unit 124 may determine that the job description is adequate. On the other hand, when the difference between the typical condition and the job performer selection condition is larger than the predetermined allowance threshold value, the adequacy evaluation unit 124 may determine that the job description is not adequate. Alternatively, the adequacy evaluation unit 124 may evaluate adequacy of the job description by using another evaluation method, based on the typical condition and the job performer selection condition.

When adequacy of the job description is evaluated, the adequacy evaluation unit 124 may output, by using the output apparatus 14, information related to a result of evaluating adequacy of the job description. For example, when it is evaluated whether adequacy of the job description is present or absent as described above, the adequacy evaluation unit 124 may output, by using the output apparatus 14, information related to a result of evaluating whether adequacy is present or absent. As a result, the user company can easily learn whether or not the job description is adequate. As an example, when the output apparatus 14 includes a display, the adequacy evaluation unit 124 may control the output apparatus 14 in such a manner that the information related to the result of evaluating adequacy is displayed. In such a case, the user company can intuitively learn whether or not the job description is adequate.

In addition to, or in place of, evaluation of adequacy of the job description, the adequacy evaluation unit 124 may output, by using the output apparatus 14, arbitrary information related to adequacy of the job description. For example, the adequacy evaluation unit 124 may output information related to the typical condition and the job performer selection condition that are used to evaluate adequacy of the job description. For example, when the output apparatus 14 includes a display, the adequacy evaluation unit 124 may display, on the output apparatus 14, a relation between the typical condition and the job performer selection condition, in the form of a radar chart that shows such relations respectively for types of items representing the conditions, distinguishably from each other, as shown in FIGS. 5a to 5c described above. Note that a display form is not limited to a radar chart. For example, the adequacy evaluation unit 124 may display a relation between the typical condition and the job performer selection condition on a display apparatus 4, for each type of an item representing the condition, in the form of a bar chart. In such a case, the user company can learn the relation between the typical condition and the job performer selection condition, by using the graph displayed on the output apparatus 14. As a result, the user company, on its own, can evaluate adequacy of the job description by comparing the typical condition and the job performer selection condition. Note that considering the fact that a user of the information processing apparatus 1 can evaluate adequacy of the job description data 1120 on its own by comparing the typical condition and the job performer selection condition as described above, the adequacy evaluation unit 124 may control the output apparatus 14 in such a manner that the typical condition and the job performer selection condition are displayed in a form that allows comparison.

The adequacy evaluation unit 124 may generate an improvement policy on the job description. For example, when the level of the job performer selection condition is unnecessarily high as shown in FIG. 5b described above, the adequacy evaluation unit 124 may generate the improvement policy of improving the job performer selection condition (that is, adjusting the condition data 1122) such that the level of the job performer selection condition is lowered. Note that processing of lowering the level of the job performer selection condition may include at least one of, for example, processing of lowering the level of the position required of the job performer, processing of lowering the level of the qualification required of the job performer, processing of lowering the level of the skill required of the job performer, and processing of lowering the remuneration to be paid to the job performer. For example, when the level of the job performer selection condition is unnecessarily high (to put it the other way around, the degree of difficulty of the to-be-performed job is too low) as shown in FIG. 5b described above, the adequacy evaluation unit 124 may generate the improvement policy of improving the to-be-performed job (that is, adjusting the to-be-performed job data 1121) such that the degree of difficulty of the to-be-performed job is raised. For example, when the level of the job performer selection condition is unnecessarily low as shown in FIG. 5c described above, the adequacy evaluation unit 124 may generate the improvement policy of improving the job performer selection condition (that is, adjusting the condition data 1122) such that the level of the job performer selection condition is raised. Note that processing of raising the level of the job performer selection condition may include at least one of, for example, processing of raising the level of the position required of the job performer, processing of raising the level of the qualification required of the job performer, processing of raising the level of the skill required of the job performer, and processing of raising the remuneration to be paid to the job performer. For example, when the level of the job performer selection condition is unnecessarily low (to put it the other way around, the degree of difficulty of the to-be-performed job is too high) as shown in FIG. 5c described above, the adequacy evaluation unit 124 may generate the improvement policy of improving the to-be-performed job (that is, adjusting the to-be-performed job data 1121) such that the degree of difficulty of the to-be-performed job is lowered. At the time, the adequacy evaluation unit 124 may display an item requiring improvement in an emphasizing manner (for example, changing the color of the item requiring improvement, changing the font size thereof, or the like).

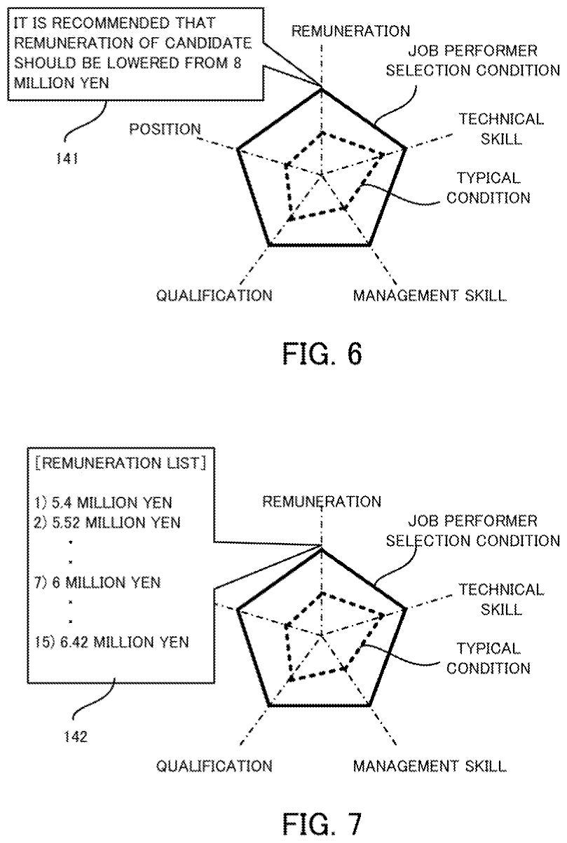

The adequacy evaluation unit 124 may control the output apparatus 14 in such a manner that the generated improvement policy is outputted. For example, when the output apparatus 14 includes a display, the adequacy evaluation unit 124 may control the output apparatus 14 in such a manner that a GUI 141 indicating the improvement policy is displayed, as shown in FIG. 6. In the example shown in FIG. 6, the GUI 141 indicates the improvement policy of improving the job performer selection condition such that the remuneration to be paid to the job performer is lowered from current eight million yen to six million yen. Note that as shown in FIG. 6, the adequacy evaluation unit 124 may control the output apparatus 14 in such a manner that the GUI 141 is displayed along with the information (graph in the present case) indicating the relation between the typical condition and the job performer selection condition. Alternatively, the adequacy evaluation unit 124 may control the output apparatus 14 in such a manner that the GUI 141 (or any displayed object indicating the improvement policy) is displayed separately from the information indicating the relation between the typical condition and the job performer selection condition. When the GUI 141 is displayed, for example, the adequacy evaluation unit 124 may switch states of the output apparatus 14 between a state of displaying the GUI 141 and a state of not displaying the GUI 141, based on an instruction made by the user using the input apparatus 13.

### (3) Technical Advantageous Effects of Information Processing Apparatus 1

As described above, the information processing apparatus 1 can output information related to adequacy of job description data 1120. Specifically, the information processing apparatus 1 can output information related to adequacy of a relation between details of a to-be-performed job and a condition for a job performer that are specified in a job description, based on the job description data 1120. Accordingly, a user company can learn, without difficulty, whether or not the job description is adequate, based on the information related to adequacy outputted by the information processing apparatus 1. As a result, the user company can improve the job description, based on the information related to adequacy outputted by the information processing apparatus 1, such that adequacy of the job description is enhanced. At the time, if the information processing apparatus 1 outputs an improvement policy on the job description as described above, the user company can easily improve the job description.

### (4) Modifications

The adequacy evaluation unit 124 may control the output apparatus 14 in such a manner that the output apparatus 14 outputs information related to a list of states of employees indicated by state data 1112 included in extracted data 1113 that is used to evaluate adequacy of a job description. In other words, the adequacy evaluation unit 124 may control the output apparatus 14 in such a manner that the output apparatus 14 outputs information related to a list of states of employees who performed past jobs that are relatively similar to a to-be-performed job. For example, when the output apparatus 14 includes a display, the adequacy evaluation unit 124 may control the output apparatus 14 in such a manner that, as shown in FIG. 7, a GUI 142 indicating the list of the states (remunerations in the example shown in FIG. 7) of the employees who performed the past jobs that are relatively similar to the to-be-performed job is displayed. In such a case, the user company can more minutely learn the states of the employees who performed the past jobs that are relatively similar to the to-be-performed job. As a result, the user company can more appropriately improve the job description, based on minuter states of the employees who performed the past jobs that are relatively similar to the to-be-performed job. Note that when the GUI 142 is displayed, the adequacy evaluation unit 124 may switch states of the output apparatus 14 between a state of displaying the GUI 142 and a state of not displaying the GUI 142, for example, based on an instruction made by the user using the input apparatus 13.

In the foregoing description, the information processing apparatus 1 is used by a company (or an individual person in some cases) that is the creator of a job description. However, the information processing apparatus 1 may be used by a company (or an individual person; the same applies hereinafter) that is not the creator of a job description. For example, the information processing apparatus 1 may be used by an advisor that provides advice related to a job description to a company that is the creator of the job description. In such a case, the advisor may provide the advice related to the job description to the company, based on information related to adequacy of the job description outputted by the information processing apparatus 1. An example of such an advisor is an outplacement agency (or an employment agency; the same applies hereinafter) that refers a human resource to a company having a job vacancy. In such a case, a job vacancy form issued by a business entity may be deemed substantially equivalent to a job description. As a result, the outplacement agency may learn adequacy of the job vacancy form equivalent to a job description, and may provide advice related to the job vacancy form to the company that is the creator of the job vacancy form.

Alternatively, in some cases, the outplacement agency refers a company to a career-change seeker (or a job seeker; the same applies hereinafter) who desires to change careers to (or to get employed in; the same applies hereinafter) a post in charge of a desired job when the company has a vacancy in the desired post. In such a case, the outplacement agency may identify a typical state (for example, at least one of a position, a qualification, a skill, and a remuneration) of an employee who performed a job of the same type as the desired job, by using the information processing apparatus 1. Specifically, the information processing apparatus 1 may identify the typical state of (that is, a typical condition for) the employee who performed the job of the same type as the desired job, by performing the evaluation operation shown in FIG. 3 by using, in place of the job description data 1120, data indicating details of the desired job to which the career-change seeker desires to change careers. More specifically, the information processing apparatus 1 may acquire the data indicating the details of the desired job (step S10 in FIG. 3), may extract, as extracted data 1113, career data 1110 with a larger degree of similarity to the data indicating the details of the desired job than the predetermined threshold value TH (steps S11 to S15 in FIG. 3), and based on state data 1112 included in the extracted extracted data 1113, may generate a typical example of the state of (that is, the typical condition for) the employee who performed the job of the same type as the desired job (step S16). Thereafter, based on the generated typical condition, the outplacement agency may provide advice to the career-change seeker. For example, the outplacement agency may provide advice related to a skill or the like that the career-change seeker lacks, by comparing the typical condition, which is a typical example of the state of the employee who performed the job of the same type as the desired job, with a current state of the career-change seeker.

Alternatively, the career-change seeker him/herself may identify a typical state (for example, at least one of a position, a qualification, a skill, and a remuneration) of an employee who performed a job of the same type as the desired job, by using the information processing apparatus 1. For example, the career-change seeker may identify the typical state of the employee who performed the job of the same type as the desired job, by using the information processing apparatus 1 included as part in a cloud service, on a web site provided by an outplacement agency. For example, the career-change seeker may execute, on a personal computer or the like held by the career-change seeker, a computer program that causes the personal computer or the like to function as the information processing apparatus 1, and by using the personal computer or the like thus functioning as the information processing apparatus 1, may identify the typical state of the employee who performed the job of the same type as the desired job. Alternatively, the career-change seeker can search for a job type that fits the own career, by operating a terminal apparatus and accessing a server on cloud computing that functions as the information processing apparatus 1. In such a case, the career-change seeker him/herself can objectively evaluate the own state of the career-change seeker, based on the typical state of, or condition for, the employee who performed the job of the same type as the desired job. Moreover, for example, the career-change seeker may learn the own suitability of the career-change seeker for the desired job. The career-change seeker him/herself may be provided with advice based on the typical state of the employee who performed the job of the same type as the desired job, by using the information processing apparatus 1. The career-change seeker can search for a job type that fits the own desire, by operating the terminal apparatus and accessing the server on cloud computing that functions as the information processing apparatus 1.

(5) Supplementary Note

With respect to the example embodiments described above, the following Supplementary Notes will be further disclosed.

### [Supplementary Note 1]

An information processing apparatus including:
an acquisition unit configured to acquire to-be-performed job data and condition data, the to-be-performed job data related to a to-be-performed job of a job performer in a predetermined post, the condition data indicating a condition for the job performer;
an extraction unit configured to extract at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job;
a generation unit configured to generate a typical condition based on the state data included in the career data extracted by the extraction unit, the typical condition supposed to be a typical example of the condition for the job performer who performs the to-be-performed job; and
an output unit configured to output adequacy information based on the condition indicated by the condition data and the typical condition, the adequacy information related to adequacy of a relation between details of the to-be-performed job indicated by the to-be-performed job data and the condition for the job performer indicated by the condition data.

### [Supplementary Note 2]

The information processing apparatus according to Supplementary Note 1, wherein
the extraction unit is configured to calculate the degree of similarity between the to-be-performed job data and the past job data.

### [Supplementary Note 3]

The information processing apparatus according to Supplementary Note 1 or 2, further including an evaluation unit configured to evaluate whether the adequacy is present or absent, based on the condition indicated by the condition data and the typical condition,
the adequacy information including information related to presence or absence of the adequacy.

### [Supplementary Note 4]

The information processing apparatus according to any one of Supplementary Notes 1 to 3, wherein
the adequacy information includes information related to an improvement policy on at least one of the details of the to-be-performed job indicated by the to-be-performed job data and the condition for the job performer indicated by the condition data.

### [Supplementary Note 5]

The information processing apparatus according to any one of Supplementary Notes 1 to 4, wherein
the output unit is configured to output, as the adequacy information, the condition indicated by the condition data and the typical condition in such a manner that the condition indicated by the condition data and the typical condition are displayed in a display form that allows comparison.

### [Supplementary Note 6]

The information processing apparatus according to any one of Supplementary Notes 1 to 5, wherein
the typical condition is a condition based on an average of the states indicated by the state data included in the extracted data.

### [Supplementary Note 7]

The information processing apparatus according to any one of Supplementary Notes 1 to 6, wherein
the typical condition is a condition based on the state indicated by the state data included in one piece of the extracted data that includes the past job data having the largest degree of similarity to the to-be-performed job data.

### [Supplementary Note 8]

The information processing apparatus according to any one of Supplementary Notes 1 to 7, wherein
the condition data indicates the condition that is related to at least one of a position required of the job performer, a qualification required of the job performer, a skill required of the job performer, and a remuneration to be paid to the job performer.

### [Supplementary Note 9]

The information processing apparatus according to any one of Supplementary Notes 1 to 8, wherein
the state data indicates the state that is related to at least one of a position of the employee, a qualification held by the employee, a skill possessed by the employee, and a remuneration paid to the employee.

### [Supplementary Note 10]

The information processing apparatus according to any one of Supplementary Notes 1 to 9, wherein
the extraction unit is configured to calculate the degree of similarity between the to-be-performed job data and the past job data, based on a distance, in a language vector space, between the to-be-performed job data and the past job data.

### [Supplementary Note 11]

An information processing method including:
acquiring to-be-performed job data and condition data, the to-be-performed job data related to a to-be-performed job of a job performer in a predetermined post, the condition data indicating a condition for the job performer;
extracting at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job;
generating a typical condition based on the state data included in the extracted career data, the typical condition supposed to be a typical example of the condition for the job performer who performs the to-be-performed job; and
outputting adequacy information based on the condition indicated by the condition data and the typical condition, the adequacy information related to adequacy of a relation between details of the to-be-performed job indicated by the to-be-performed job data and the condition for the job performer indicated by the condition data.

### [Supplementary Note 12]

A recording medium storing a computer program that causes a computer to execute an information processing method,
the information processing method including:
acquiring to-be-performed job data and condition data, the to-be-performed job data related to a to-be-performed job of a job performer in a predetermined post, the condition data indicating a condition for the job performer;
extracting at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job;
generating a typical condition based on the state data included in the extracted career data, the typical condition supposed to be a typical example of the condition for the job performer who performs the to-be-performed job; and
outputting adequacy information based on the condition indicated by the condition data and the typical condition, the adequacy information related to adequacy of a relation between details of the to-be-performed job indicated by the to-be-performed job data and the condition for the job performer indicated by the condition data.

### [Supplementary Note 13]

A computer program that causes a computer to execute an information processing method,
the information processing method including:
acquiring to-be-performed job data and condition data, the to-be-performed job data related to a to-be-performed job of a job performer in a predetermined post, the condition data indicating a condition for the job performer;
extracting at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job;
generating a typical condition based on the state data included in the extracted career data, the typical condition supposed to be a typical example of the condition for the job performer who performs the to-be-performed job; and
outputting adequacy information based on the condition indicated by the condition data and the typical condition, the adequacy information related to adequacy of a relation between details of the to-be-performed job indicated by the to-be-performed job data and the condition for the job performer indicated by the condition data.

### [Supplementary Note 14]

An information processing apparatus including:
an acquisition unit configured to acquire to-be-performed job data and condition data, the to-be-performed job data related to a to-be-performed job of a job performer in a predetermined post, the condition data indicating a condition for the job performer;
a generation unit configured to generate a typical condition supposed to be a typical example of the condition for a candidate for the job performer who performs the to-be-performed job, based on state data included in career data that is similar to the to-be-performed job data, among pieces of the career data, the career data including past job data and the state data, the past job data indicating details of a past job performed by an employee in the past, the state data indicating a state of the employee at a time of performing the past job; and
an output unit configured to output adequacy information based on the condition indicated by the condition data and the typical condition, the adequacy information related to adequacy of a relation between details of the to-be-performed job indicated by the to-be-performed job data and the condition for the candidate for the job performer indicated by the condition data.

The present invention can be changed as appropriate within the scope that does not contradict the gist or the idea of the invention that can be read from claims and the specification in its entirety, and the information processing apparatus, the information processing method, and the recording medium involving such changes are also included in the technical idea of the present invention.

### DESCRIPTION OF REFERENCE CODES

1 Information processing apparatus
11 Storage apparatus
111 Career DB
1110 Career data
1111 Past job data
1112 State data
1120 Job description data
1121 To-be-performed job data
1122 Condition data
12 Computation apparatus
121 Data acquisition unit
122 Determination unit
123 Condition generation unit
124 Adequacy evaluation unit

What is claimed is:

1. An information processing apparatus comprising:
at least one memory configured to store instructions; and
at least one processor configured to execute the instructions to:
acquire to-be-performed job data and condition data, the to-be-performed job data related to a to-be-performed job of a job performer in a predetermined post, the condition data indicating a condition for the job performer;
extract at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job;
generate a typical condition based on the state data included in the extracted career , data, the typical condition supposed to be a typical example of the condition for the job performer who performs the to-be-performed job; and
output adequacy information based on the condition indicated by the condition data and the typical condition, the adequacy information related to adequacy of a relation between details of the to-be-performed job indicated by the to-be-performed job data and the condition for the job performer indicated by the condition data.

2. The information processing apparatus according to claim 1, wherein
the at least one processor is configured to execute the instructions to calculate the degree of similarity between the to-be-performed job data and the past job data.

3. The information processing apparatus according to claim 1, wherein, the at least one processor is further configured to execute the instructions to evaluate whether the adequacy is present or absent, based on the condition indicated by the condition data and the typical condition,
the adequacy information including information related to presence or absence of the adequacy.

4. The information processing apparatus according to claim 1, wherein
the adequacy information includes information related to an improvement policy on at least one of the details of the to-be-performed job indicated by the to-be-performed job data and the condition for the job performer indicated by the condition data.

5. The information processing apparatus according to claim 1, wherein
the at least one processor is configured to execute the instructions to output, as the adequacy information, the condition indicated by the condition data and the typical condition in such a manner that the condition indicated by the condition data and the typical condition are displayed in a display form that allows comparison.

6. The information processing apparatus according to claim 1, wherein
the typical condition is a condition based on an average of the states indicated by the state data included in the extracted data.

7. The information processing apparatus according to claim 1, wherein
the typical condition is a condition based on the state indicated by the state data included in one piece of the extracted data that includes the past job data having the largest degree of similarity to the to-be-performed job data.

8. The information processing apparatus according to claim 1, wherein
the condition data indicates the condition that is related to at least one of a position required of the job performer, a qualification required of the job performer, a skill required of the job performer, and a remuneration to be paid to the job performer.

9. The information processing apparatus according to claim 1, wherein
the state data indicates the state that is related to at least one of a position of the employee, a qualification held by the employee, a skill possessed by the employee, and a remuneration paid to the employee.

10. The information processing apparatus according to claim 1, wherein
the at least one processor is configured to execute the instructions to calculate the degree of similarity between the to-be-performed job data and the past job data, based on a distance, in a language vector space, between the to-be-performed job data and the past job data.

11. An information processing method comprising:
acquiring to-be-performed job data and condition data, the to-be-performed job data related to a to-be-performed job of a job performer in a predetermined post, the condition data indicating a condition for the job performer;
extracting at least one piece of career data among pieces of the career data based on a degree of similarity to the to-be-performed job data, the career data including past job data and state data, the past job data indicating details of a past job performed by an employee in the past, the state data indicating a state of the employee at a time of performing the past job;
generating a typical condition based on the state data included in the extracted career data, the typical condition supposed to be a typical example of the condition for the job performer who performs the to-be-performed job; and
outputting adequacy information based on the condition indicated by the condition data and the typical condition, the adequacy information related to adequacy of a relation between details of the to-be-performed job indicated by the to-be-performed job data and the condition for the job performer indicated by the condition data.

12. (canceled)

13. An information processing apparatus comprising:
at least one memory configured to store instructions; and
at least one processor configured to execute the instructions to:
acquire to-be-performed job data and condition data, the to-be-performed job data related to a to-be-performed job of a job performer in a predetermined post, the condition data indicating a condition for the job performer;
generate a typical condition supposed to be a typical example of the condition for a candidate for the job performer who performs the to-be-performed job, based on state data included in career data that is similar to the to-be-performed job data, among pieces of the career data, the career data including past job data and the state data, the past job data indicating details of a past job performed by an employee in the past, the state data indicating a state of the employee at a time of performing the past job; and
output adequacy information based on the condition indicated by the condition data and the typical condition, the adequacy information related to adequacy of a relation between details of the to-be-performed job indicated by the to-be-performed job data and the condition for the candidate for the job performer indicated by the condition data.
